(19) United States
(12) Patent Application Publication
(10) Pub. No.: US 2003/0210713 A1
(43) Pub. Date: Nov. 13, 2003

(54) Estimating a time offset between link points in a communication network operating in a frequency division duplex mode

(76) Inventor: Hisham Abdel-Ghaffar, Eatontown, NJ (US)

Correspondence Address: HARNESS, DICKEY & PIERCE, P.L.C., P.O. BOX 8910, RESTON, VA, 20195, US

(21) Appl. No.: 10/142,768

(22) Filed: May 13, 2002

(51) Int. Cl. H04J 3/06; H04Q 7/28

(52) U.S. Cl. 370/503; 370/341

(57) ABSTRACT

In the method of estimating a time offset between link points in a communication network operating in frequency division duplex mode, a time offset between first and second link points is estimated based on communication measurements made by user equipment communicating with the first and second link points.

### BACKGROUND OF THE INVENTION

1. Field of the Invention

The present invention relates to determining a time offset estimate between link points such as nodes and/or cells in a communication network operating in a frequency division duplex mode.

2. Description of Related Art

Clock synchronization is an extremely important problem for networks and systems with distributed resources. In many cases, network nodes (e.g., base stations) or coverage areas (e.g., an entire cell if an omnidirectional antenna is used or sectors when directional antennas are used) need synchronized to a common reference known as Coordinated Universal Time (UTC), simply denoted as “t”. One way of achieving this goal is to use clock radio receivers of satellite-based systems such as the Global Positioning System (GPS). In situations where GPS is unavailable or not utilized such as in the frequency division duplex (FDD) mode of the 3^{rd} Generation Partnership Project (3GPP), different nodes of the network will set their own local timings as a totally random function of the UTC time “t”.

Node or coverage area synchronization then becomes a problem of “finding out” or “estimating” the differences or offsets between local node timing references. Node synchronization is a problem of prime importance in many systems (e.g., the Internet, wireless network systems, etc). And, the problem of node synchronization is particularly acute in networks that have nodes with periodic local timing.

### SUMMARY OF THE INVENTION

In estimating a time offset according to the present invention, measurements made by end user equipment, hereinafter referred to as user equipment or UE, are used to determine a time offset between two link points in a communication network operating in a frequency division duplex mode. The time offset is then used to synchronize the link points. In a network, the link points are nodes of the network. In a wireless environment, the link points are, for example, base stations of the wireless network. If a base station has an omni-directional antenna, then the base station has a single coverage area, typically called as cell. If the base station has directional antennas, then the base station has more than one coverage area, each called a sector. According to 3GPP, each antenna of a base station transmits at a different predetermined offset to balance the load on the base station resources. As such, each cell or sector is also a link point, or in a different sense, each antenna is also a link point.

In one embodiment, the measurements made by the user equipment include (a) a timing phase difference between receipt of a frame from the first link point by the user equipment and receipt of a frame from the second link point by the user equipment, (b) a first receive/transmit differential, which is a time difference between when information is received from the first link point and an associated response is sent to the first link point, and (c) a second receive/transmit differential, which is a time difference between when information is received from the second link point and an associated response is sent to the second link point. The first and second link points also make measurements used in estimating the time offset. The first link point measures a first round trip transmit/receive differential, which is a time difference between when information is transmitted by the first link point to the user equipment and an associated response is received from the user equipment. The second link point measures a second round trip transmit/receive differential, which is a time difference between when information is transmitted by the second link point to the user equipment and an associated response is received from the user equipment. A first down link propagation delay from the first link point to the user equipment is estimated based on the first receive/transmit differential and the first round trip transmit/receive differential, and a second downlink propagation delay from the second link point to the user equipment is estimated based on the second receive/transmit differential and the second round trip transmit/receive differential. Then, an initial time offset between the first and second link points based on the first and second estimated downlink propagation delays and the timing phase difference.

Additionally, the measurements made by the user equipment include a frame difference between a frame number for a frame received from the first link point by the user equipment and a frame number for a frame received from the second link point by the user equipment, and the initial time offset estimate is corrected for wrap around based on the frame difference.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a portion of a generic, well-known network structure;

FIG. 2 illustrates the local timings of the RNC, Node Bᵢ and Node B_{q} in a 3GPP wireless system;

FIG. 3 illustrates the common channel observations made according to the method of the present invention; and

FIG. 4 illustrates the dedicated channel observation made according to the method of the present invention.

### DETAILED DESCRIPTION OF EMBODIMENTS

To provide a clear understanding of the invention, terminology used in describing the invention will be defined and defined in a contextual environment. Specifically, periodic local time mapping relations for node synchronization will be discussed, followed by a discussion of node synchronization metrics and definitions. Then, physical measurements to estimate a time offset between nodes and/or cells (i.e., universally referred to as link points) will be discussed. Next, the method of determining a time offset estimate according to the present invention will be described.

Periodic Local Timing Mapping Relations for Node Synchronization

FIG. 1 illustrates a portion of a generic, well-known network structure. As shown, the network structure includes a central node R (e.g., in a wireless network—a mobile switching center, base station, etc.) connected to a plurality of secondary nodes B (e.g., in a wireless network—a base station, base station, etc.), which in a wireless environment are in communication with equipment used by an end user (e.g., architecture including a mobile station) hereinafter referred to as user equipment (UE). Communication between the nodes R, B occurs according to any well-known basis such as frame-by-frame. For the purposes of explanation only, node synchronization will be explained for network nodes operating on a local frame-by-frame timing basis wherein a frame is defined as the local time unit of nodes R, B of predetermined duration t_{f}. In such networks, each node R, B traces the frame number FN and the frame time FT of consecutive frames. The local tracing extends up to a “Superframe” of duration T_{f}=N_{f}*t_{f} and then periodically repeats itself, where N_{f} equals the number of frames per superframe and T_{f} defines the overall system period for all network nodes. The invention framework can be adapted to arbitrary values of t_{f} and T_{f} such that N_{f} equals an even integer. For example, in 3GPP t_{f}=10 ms and T_{f}=4096*t_{f}=40.96 sec. Also, in 3GPP, the central network node R is known as the Radio Network Controller (RNC) and is centrally connected to a number of other nodes Bᵢ, i=1, 2, . . . , via an interface called the Iub interface, where node Bᵢ's comprise the functionality of cellular sites. In this and the following notations it is assumed for the purposes of simplifying the description that the contextual environment is a wireless system according to 3GPP and that cell j belongs to Node Bᵢ and cell k belongs to Node B_{q}, where T_{cell,ij} and T_{cell,qk} represent the corresponding Node B—cell offset values. However, is should be understood that the present invention is not limited to this contextual environment.

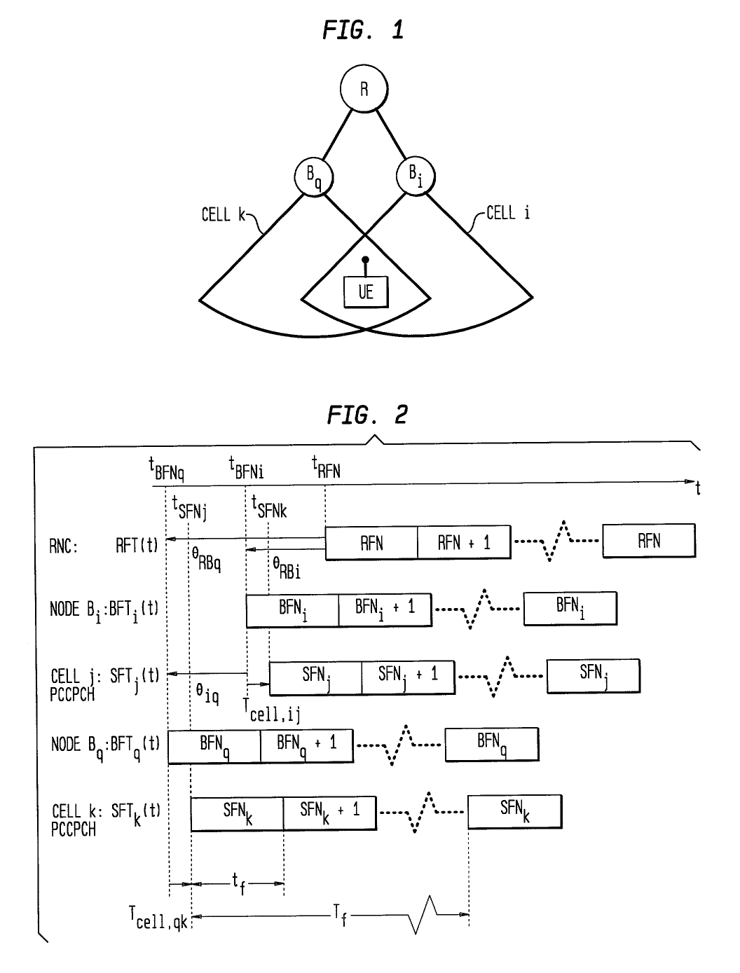

The local timings of the RNC, Node Bᵢ and Node B_{q}, as depicted in FIG. 2, are periodic in modulo T_{f} format and the associated RNC Frame Number (RFN), Node Bᵢ & B_{q} Frame Number (BFNᵢ & BFN_{q}) are also periodic integers in modulo 4096 format (i.e., RFN, BFN=0, 1, . . . , 4095). The RNC frame time (RFT) and Node Bᵢ & B_{q} frame time (BFTᵢ & BFT_{q}) can be defined to map the RFN, BFNᵢ, & BFN_{q} respectively, as a function of “t” as follows:

RFT(t)=hᵣₑₛ[(t−t_{RFN}) mod t_{f}]+RFN*t_{f} [symbol] RFT(t+T_{f})=RFT(t)

BFTᵢ(t)=hᵣₑₛ[(t−t_{BFNi}) mod t_{f}]+BFNᵢ*t_{f} [symbol] BFTᵢ (t+T_{f})=BFTᵢ(t)

BFT_{q}(t)=hᵣₑₛ[(t−t_{BFNq}) mod t_{f}]+BFN_{q}*t_{f} [symbol] BFT_{q} (t+T_{f})=BFT_{q}(t)

where hᵣₑₛ(t)=0, Δᵣₑₛ, 2*Δᵣₑₛ, . . . , t_{f}−Δᵣₑₛ is a staircase function defined within t=[0, t_{f}) with resolution Δᵣₑₛ<<t_{f}. In FIG. 2, PCCPCH represents a downlink control channel in 3GPP, SFN represents the cell frame number and SFT represents the cell frame time. Currently, 3GPP sets a value of Δᵣₑₛ=0.125 m sec when the usage is RNC-Node B synchronization, i.e., {RFT, BFT}=0, Δᵣₑₛ, 2*Δᵣₑₛ, . . . T_{f}−Δᵣₑₛ.

Time Mapping Between Nodes B_{q} and Bᵢ

Node Bᵢ-B_{q} Time Mapping

Assuming, without loss of generality, that BFNᵢ and BFN_{q} are calculated in the above equations such that the BFNᵢ^{th} frame lags the BFN_{q}^{th} frame, i.e., the time epochs t_{BFNi} and t_{BFNq} (see FIG. 2) are configured such that:

θ_{iq}=(t_{BFNi}−t_{BFNq}), 0<θ_{iq}<t_{f}.

When the usage is through direct air interface physical measurements, θ_{iq} can be measured with a resolution equal to a 3GPP chip interval, or 260.4 n sec, which provides a much better accuracy than Inter-Node B synchronization via RNC-Node B synchronization due to the worse resolution of the latter. The remainder of this disclosure will focus only on BFTᵢ and BFT_{q}, since RFT will not play any particular role in the method according to this invention.

To complete Node Bᵢ-B_{q} time mapping, the BFTᵢ-BFT_{q} can be related as follows:

BFT_{q}=BFTᵢ(t+Y_{iq}) [symbol] BFTᵢ=BFT_{q}(t−Y_{iq})

where Y_{iq} is the total time offset between nodes B_{q} and Bᵢ, given by:

Y_{iq}=[(BFN_{q}−BFNᵢ)*t_{f}+θ_{iq}]mod T_{f}=N_{iq}*t_{f}+θ_{iq}

and,

N_{iq}=(BFN_{q}−BFNᵢ) mod 4096

where “mod” is the modulus. Thus, the time offset Y_{iq} consists of an index offset N_{iq} and a subframe phase offset θ_{iq}.

Node B_{q}-Bᵢ Inverse Time Mapping

The inverse relation, i.e. the time offset of Node Bᵢ relative to Node B_{q} using the same values of BFNᵢ, BFN_{q} and θ_{iq}, is obtained by:

Y_{qi}=N_{qi}*t_{f}+θ_{qi}

where,

N_{qi}=(BFNᵢ−1−BFN_{q}) mod 4096

θ_{qi}=t_{f}−θ_{iq}

Thus, inverse relative time-mapping of two nodes with periodic timing can be done in a fairly simple manner.

Time Mapping Between Cell k of Node B_{q} and Cell j of Node Bᵢ

Cell timing is defined by the System Frame Time (SFT) and System Frame Number (SFN) of the cell's downlink (DL) transmission of a common channel called the Primary Common Control Physical CHannel, or PCCPCH. The periodicity of SFT and SFN is exactly the same as that of BFT and BFN. The cell timing is used to map the timing for both common and dedicated transport channels to the user equipment (UE). Suppose t₂₅₆=(1/15) ms=66.67 μs is the duration of 256 chips or 1/10 of a time slot in 3GPP. As shown in FIG. 2, cell timing relates to its Node B timing via the cell offset parameter T_{cell}=0, t₂₅₆, 2*t₂₅₆, . . . , 9*t₂₅₆, which is different for all cells belonging to a particular Node B. The inter cell analysis in this section refers to the non-trivial case when Nodes Bᵢ and B_{q} are different, or otherwise the relation would be straightforward via T_{cell}. For mapping purposes, the same time offset, index offset and phase offset variables Y, N, θ as before, but with subscripts j, k instead of i, q will be used. The SFT's of cells j, k are given as follows:

SFTⱼ(t)=hᵣₑₛ[(t−t_{SFNj}) mod t_{f}]+SFNⱼ*t_{f}

SFTₖ(t)=hᵣₑₛ[(t−t_{SFNk}) mod t_{f}]+SFNₖ*t_{f}

Furthermore, it will be assumed that SFNⱼ and SFNₖ are calculated in the above equations such that the SFNⱼ^{th} frame lags the SFNₖ^{th} frame, i.e., the time epochs t_{SFNj} and t_{SFNk} are configured such that:

θⱼₖ=(t_{SFNj}−t_{BFNk}), 0≦θⱼₖ<t_{f}.

Similarly, the SFTⱼ-SFTₖ can be related as follows:

SFTₖ=SFTⱼ(t+Yⱼₖ) [symbol] SFTⱼ=SFTₖ(t−Yⱼₖ)

where Yⱼₖ is the total time offset between cells j,k given by:

Yⱼₖ=[(SFNₖ−SFNⱼ)*t_{f}+θⱼₖ ]mod T_{f}=Nⱼₖ*t_{f}+θⱼₖ

and,

Nⱼₖ=(SFNₖ−SFNⱼ) mod 4096

Thus, the time offset Yⱼₖ consists of an index offset Nⱼₖ and a subframe phase offset θⱼₖ.

Time Mapping of Nodes Bᵢ & B_{q} to Cells j & k

Performing the inter-Node B to inter-cell mapping defines the usage of inter-Node B time offsets in computing inter-cell time offsets for all cells belonging to each Node B pair.

SFTⱼ(t)=BFTᵢ(t−T_{cell,ij}) [symbol] BFTᵢ(t)=SFTⱼ(t+T_{cell,ij})

SFTₖ(t)=BFT_{q}(t−T_{cell,qk}) [symbol] BFT_{q}(t)=SFTₖ(t+T_{cell,qk})

Substituting BFT_{q}(t)=BFTᵢ(t+Y_{iq}), results in:

$$\begin{matrix}{SFT}_{k} ( t ) = {BFT}_{i} ( t + {Y}_{iq} - {T}_{cell , qk} ) = {SFT}_{j} \{ t + {Y}_{iq} + ( {T}_{cell , ij} - {T}_{cell , qk} ) \} \\ = {SFT}_{j} ( t + {Y}_{jk} )\end{matrix}$$

The inter-cell time offset Yⱼₖ is therefore given by:

$$\begin{matrix}{Y}_{jk} = [ {Y}_{iq} + ( {T}_{cell , ij} - {T}_{cell , qk} ) ] mod {T}_{f} \\ = [ {N}_{iq} * {t}_{f} + {θ}_{iq} + ( {T}_{cell , ij} - {T}_{cell , qk} ) ] mod {T}_{f} \\ = {N}_{jk} * {t}_{f} + {θ}_{jk}\end{matrix}$$

The inter-cell distance variable is defined as,

λⱼₖ=θ_{iq}+(T_{cell,ij}−T_{cell,qk})

The inter-cell index and phase offsets Nⱼₖ & θⱼₖ can be obtained as:

If λⱼₖ<0 [symbol] θⱼₖ=t_{f}+λⱼₖ & Nⱼₖ=(N_{iq}+1) mod 4096

If λⱼₖ≧0 [symbol] θⱼₖ=λⱼₖmod t_{f} & Nⱼₖ=(N_{iq}−└λⱼₖ/t_{f}┘) mod 4096

where └.┘ is the floor function. Thus, the inter-Node B to inter-cell mapping is complete.

Time Mapping of Cells j, k to Nodes Bᵢ & B_{q}

Alternatively, mapping of time offsets for any particular pair of cells j,k to time offsets of for their Nodes Bᵢ and B_{q}, will provide the offset time information for all cells belonging to Nodes Bᵢ and B_{q}.

Using the above described relations, the inter-cell offset Yⱼₖ=Nⱼₖ*t_{f}+θⱼₖ can be mapped to the inter-Node B offset Y_{iq}=N_{iq}*t_{f}+θ_{iq} as follows:

Y_{iq}=[Yⱼₖ−(T_{cell,ij}−T_{cell,qk})]mod T_{f}=[Nⱼₖ*t_{f}+θⱼₖ−(T_{cell,ij}−T_{cell,qk})]mod T_{f}

The inter-Node B distance variable is defined as,

λ_{iq}=θⱼₖ−(T_{cell,ij}−T_{cell,qk})

Similarly, the inter-Node B index and phase offsets can be obtained as:

If λ_{iq}<0 [symbol] θ_{iq}=t_{f}+λ_{iq} & N_{iq}=(Nⱼₖ+1) mod 4096

If λ_{iq}≧0 [symbol] θ_{iq}=λ_{iq} mod t_{f} & N_{iq}=(Nⱼₖ−└λ_{iq}/t_{f}┘) mod 4096

Inter-Node B Synchronization Metrics and Definitions

Inter-Node B synchronization procedure in this invention involves, in a 3GPP wireless environment, the RNC (or alternatively, one of the Node Bs) performing the following computational steps:

1. Computation of an inter-cell time offset estimate Ŷⱼₖ=\hat{N}ⱼₖ*t_{f}+\hat{θ}ⱼₖ and then mapping it to an inter-Node B estimate Ŷ_{iq}=\hat{N}_{iq}*t_{f}+\hat{θ}_{iq} using the same mapping relations between Yⱼₖ=Nⱼₖ*t_{f}+θⱼₖ and Y_{iq}=N_{iq}*t_{f}+θ_{iq}.

2. Computation of other inter-cell time offset estimates Ŷⱼₖ=\hat{N}_{j,k}*t_{f}+\hat{θ}ⱼₖ, for all other {j,k} pairs using the available inter-Node B estimate Ŷ_{iq}=\hat{N}_{iq}*t_{f}+\hat{θ}_{iq} from step 1. The inter-cell time offset estimate Ŷⱼₖ is generally prone to an estimation error εⱼₖ with variance σ²ⱼₖ, such that:

Ŷⱼₖ=[Yⱼₖ+εⱼₖ]mod T_{f}

Hence the error can propagate to the inter-cell index offset estimate \hat{N}ⱼₖ phase offset estimate \hat{θ}ⱼₖ or both. Mapping the inter-cell offset estimate to the inter-Node B offset estimate (or vice versa) is performed by replacing {Y_{iq}, N_{iq}, θ_{iq}} with {Ŷ_{iq}, \hat{N}_{iq}, \hat{θ}_{iq}} and also replacing {Yⱼₖ, Nⱼₖ, θⱼₖ} with {Ŷⱼₖ, \hat{N}ⱼₖ, \hat{θ}ⱼₖ} in the mapping equations. Since this mapping process is based on well known parameters (T_{cell} values), the inter-Node B offset estimate Ŷ_{iq} will also be prone to an estimation error ε_{iq} with variance σ²_{iq}, such that:

Ŷ_{iq}=[Y_{iq}+ε_{iq}]mod T_{f}

and,

ε_{iq}=εⱼₖσ²_{iq}=σ²ⱼₖ

That is, the estimation error and its variance will be the same for Nodes Bᵢ and B_{q} and for all pairs of cells {j, k} belonging to these two Nodes Bs.

Physical Measurements to Estimate a Time Offset

FDD Physical Measurements for Inter-Node B Synchronization

A whole well-known set of air interface UE and UTRAN (i.e., cell) physical measurements in FDD mode has been defined in 3GPP from an abstract point of view, in terms of measurements of powers, relative time epochs and frame numbers, etc. Some of these measurements are needed for radio synchronization, while others were just proposed to the 3GPP standard for potential use in other applications. According to the 3GPP standard, the RNC sends commands for UTRAN (cell) measurements via the Node B Application Part (NBAP) signaling, and it sends commands for UE measurements via the Radio Resource Control (RRC) signaling. The applicability of such measurements depends on the specific physical connection scenario in which the UE and UTRAN are involved. Four main scenarios have been defined by 3GPP as follows:

1. Scenario 1—UE in common channel state (one cell)

2. Scenario 2—UE changes from common channel state (one cell) to dedicated channel state (one cell), 1 radio link (RL)

3. Scenario 3—UE changes from common channel state (one cell) to dedicated channel state (cells 1-n)

4. Scenario 4—New radio link (RL) (cell n+1) added in dedicated channel state (Macrodiversity)

Scenario 1 represents a UE communicating with a cell over common transport channels whose downlink (DL) timing is explicitly defined by the SFT of the PCCPCH physical channel. Scenarios 2 or 3 represent a UE switching to a dedicated mode from a common mode. Communication in the dedicated mode is established over a dedicated transport channel called the Dedicated CHannel (DCH) which is transmitted over a physical channel called Dedicated Physical CHannel (DPCH). Timing of the DCH/DPCH channel is based on Layer 2 (L2) Connection Frame Time (CFT) and Connection Frame Number (CFN) in 3GPP. The CFT is also periodic with period, T_{CFN}=256*t_{f}=2.56 sec. The SFT-CFT (or PCCPCH-DPCH) time mapping is established via two parameters called Frame_Offset (FO) and Chip_Offset (CO) computed by the RNC and passed to Node B via NBAP signaling.

The UE can continue establishing more RL's in the dedicated mode via scenario 4. In scenario 4, the UE performs a “CFN-SFN observed time difference” measurement. Other scenarios are defined in 3GPP which can be actually reduced to some of the above scenarios from a functional point of view.

The application of physical measurements for the purpose of Inter-Node B synchronization requires a thorough analysis of the air interface timing in common and dedicated modes. This analysis is presented in the following section and aims to provide analytical interpretations of the relevant air interface timing parameters.

Air Interface Timing Analysis in Common and Dedicated Modes

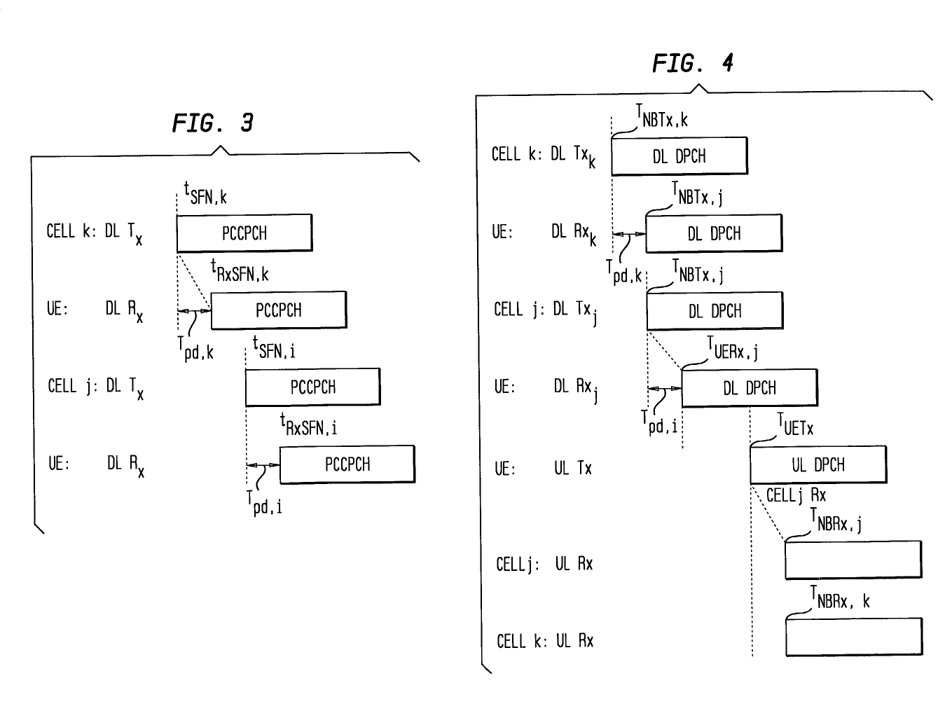

The timing analysis in this section refers to the timing diagrams of FIGS. 3 and 4.

Common Channel Observations:

The common channel observations apply to all 4 scenarios and will be described with respect to FIG. 3. FIG. 3 illustrates the downlink transmission of a frame by cell k over the PCCPCH at time t_{SFN,k} and the subsequent reception of the frame by the UE at time T_{RxSFN,k}. FIG. 3 further illustrates the downlink transmission of a frame by cell j over the PCCPCH at time t_{SFNj} and the subsequent reception of the frame by the UE at time T_{RxSFNj}. The UE first acquires the PCCPCH channel of the j^{th} cell, which will be considered the pivot cell. The UE is then responsible for tracking and measuring the received PCCPCH frame boundary for cell j with frame number SFNⱼ at receive start time epoch T_{RxSFNj}. Note that T_{RxSFNj} is stamped (measured) by the UE in order to maintain the UE reference for physical measurements in other subsequent scenarios, hence it is not, by itself, a reportable physical measurement by the UE. However, without any loss of generality, T_{RxSFNj} can be viewed according to the same time reference of the first cell (cell j). Thus, T_{RxSFNj} can be related to the cell j DL transmit time t_{SFNj} as follows:

T_{RxSFNj}=t_{SFNj}+T_{pd,j}

where T_{pd,j} is the DL propagation delay of the radio (Uu) interface between cell j and the UE (see FIG. 3).

When other cells (say cell k) are acquired by the UE, either via informed or uninformed search, the UE can also track the SFNₖ receive start time epoch given by:

T_{RxSFN,k}=t_{SFN,k}+T_{pd,k}

where T_{pd,k} is the DL propagation delay of the radio (Uu) interface between cell k and the UE (see FIG. 3).

Dedicated Channel Observations:

The dedicated channel observations generally apply to scenarios 2,3,and 4, and will be described with respect to FIG. 4. FIG. 4 illustrates the downlink transmission of a frame by cell k over a DL DPCH at time T_{NBTx,k} and the subsequent reception of the frame by the UE at time T_{UERx,k}. The downlink transmission of a frame by cell j over a DL DPCH at time T_{NBTx,j} and subsequent reception by the UE at time T_{UERx,j} is also illustrated. FIG. 4 further illustrates the responsive uplink (UL) transmission by the UE over a UL DPCH at time T_{UETx} and the subsequent reception thereof by the cells k and j at times T_{NBRx,k} and T_{NBRx,j}, respectively. However, scenario 2 is not of any help in providing a useful outcome since multiple cells cannot be viewed together in dedicated mode. As mentioned before, establishment of the CFN frame boundary (start time epoch) of the DPCH relative to the PCCPCH channel requires two parameters FO and CO, where the method of computation depends on the particular scenario and is not of interest in this context. Accordingly, it is assumed that the CFNⱼ time epoch of cell j's DPCHⱼ DL transmitter is equal to T_{NBTx,j}, where the absolute value of T_{NBTx,j} does not matter.

At the UE side, the UE receives the “first significant path” of the DL DPCHⱼ channel at time epoch:

T_{UERx,j}=T_{NBTx,j}+T_{pd,j}

The UE acquires the DL DPCHⱼ by capturing and tracking T_{UERx,j}. Having acquired the DPCHⱼ channel, the UE captures a certain (nominal) snapshot of T_{UERx,j} called DPCHₙₒₘ to establish a Soft Hand-Over (SHO) reference. The DPCHₙₒₘ is given by:

T_{UERx,nom}=T_{NBTx,j}+T_{pd,j, nom}

where T_{pd,j,nom} is the corresponding snapshot of T_{pd,j}. Let, α(T_{pd,j})=T_{pd,j,nom}−T_{pd,j}, be defined as the dispersion factor of cell j, which is an unknown variable. Substituting in the two equations above, the following is obtained:

T_{UERx,nom}=T_{UERx,j}+α(T_{pd,j})

Thus, a constant reference T_{UERx,nom} is expressed in terms of a dispersed reference T_{UERx,j} and a dispersion factor α(T_{pd,j}). Having determined T_{UERx,nom}, the UE starts UL DPCHⱼ transmission after a duplex time T₀=4*t₂₅₆ (i.e., 1024 chips). The UE UL DPCHⱼ transmission time is given by:

$$\begin{matrix}{T}_{UETx , j} = {T}_{UERx , nom} + {T}_{0} \\ = {T}_{UERx , j} + {T}_{0} + α ( {T}_{pd , j} ) \\ = {T}_{NBTx , j} + {T}_{pd , j} + {T}_{0} + α ( {T}_{pd , j} )\end{matrix}$$

Note that T_{UERx,nom}=(T_{UETx} −T₀) is then considered the SHO reference by the UE.

Finally, Node Bᵢ, cell j will then receive the UL DPCH frame from the UE at time epoch:

$$\begin{matrix}{T}_{NBRx , j} = {T}_{UETx} + {T}_{pu , j} \\ = {T}_{NBTx , j} + ( {T}_{pd , j} + {T}_{pu , j} ) + {T}_{0} + α ( {T}_{pd , j} )\end{matrix}$$

where T_{pu,j} is the Uu UL propagation delay for cell j.

UE-Measured “SFN-SFN Observed The Difference”

The RNC can command the UE (via RRC signaling) to perform the “SFNⱼ-SFNₖ observed time difference” measurement for all pairs of cells in the connection. The UE continues to track and observe the PCCPCH boundaries, i.e., T_{RxSFN,j} for cell j as well as T_{RxSFN,k} for all cells k. When the UE is commanded to perform this measurement, the UE configures SFNⱼ and SFNₖ such that T_{RxSFN,j}≧T_{RxSFN,k} within less than a frame period (same lead/lag approach as before). Then the UE performs the following computations:

T_{m,k}=T_{RxSFN,j}−T_{RxSFN,k}, T_{m,k}=0, 1, . . . , 38399 chips,

i.e.,

0≦T_{m,k}<t_{f}

OFFₖ=(SFNₖ−SFNⱼ) mod 256, OFFₖ=0, 1, . . . , 255.

According to the analysis above, the UE measurement can be expressed as follows:

$$\begin{matrix}{T}_{m , k} = ( {t}_{SFN , j} + {T}_{pd , j} ) - ( {t}_{SFN , k} + {T}_{pd , k} ) = ( {t}_{SFN , j} - {t}_{SFN , k} ) + ( {T}_{pd , j} - {T}_{pd , k} ) \\ = {θ}_{jk} + ( {T}_{pd , j} - {T}_{pd , k} ) \\ {OFF}_{k} = ( {SFN}_{k} - {SFN}_{j} ) mod 256\end{matrix}$$

OFFₖ=(SFNₖ−SFNⱼ) mod 256

where θⱼₖ is the subframe phase offset between cells j, k. The timing phase difference measurement T_{m,k} and the frame difference OFFₖ are sent by the UE to the RNC via a Node B.

UE-Measured “UE Rx-Tx Time Difference”

The RNC can command the UE (via RRC signaling) to perform the “UE Rx-Tx time difference” measurement for all cells in the dedicated mode, which is given by:

ΔT_{UE,j}=T_{UETx}−T_{UERx,j}=[T₀+α(T_{pd,j})]

ΔT_{UE,k}=T_{UETx}−T_{UERx,k}=[T₀+α(T_{pd,k})]

The applicability of this measurement is in scenarios 2, 3, 4 with dedicated mode.

According to the analysis given above, the UE Rx-Tx time difference measurement can be expressed as:

ΔT_{UE,j}=[T₀+α(T_{pd,j})]

ΔT_{UE,k}=[T₀+α(T_{pd,k})]

The Rx-Tx time difference measurements are also sent by the UE to the RNC.

UTRAN-Measured “Round-Trip-Time” (RTT)

The RNC can command all cells in the dedicated mode (via NBAP signaling) to perform (substantially simultaneously with the UE-measured “UE Rx-Tx time difference”) the “Round-Trip Time (RTT)” measurement as follows:

RTTⱼ=T_{NBRx,j}−T_{NBTx,j}

RTTₖ=T_{NBRx,k}−T_{NBTx,k}

The applicability of this measurement is also in scenarios 2, 3, 4 with dedicated mode.

According to the analysis given above, the RTT measurements can be expressed as follows:

RTTⱼ=(T_{pd,j}+T_{pu,j})+T₀+α(T_{pd,j})

RTTₖ=(T_{pd,k}+T_{pu,k})+T₀+α(T_{pd,k})

The cells return the round trip time measurements to the RNC.

Estimation of Time Offset

The UE that performs the standalone measurement will be referred to as the “originator UE”. The UE that receives the phase offset information in the neighbor list will be referred to as the “recipient UE”. Any UE can be originator or recipient, even in the same connection. However, originally upon system start up, many originator UE's Uis cannot be recipient because the offset estimates are not available yet to the RNC.

Estimation of the Air Interface DL Propagation Delay

As discussed above, the RNC commands the UE and nodes Bi and Bq to make the above-described measurements, which are then sent back to the RNC. Using these measurements, the RNC determines an estimation of the time offset between cells. Specifically, the RNC first estimates the DL propagation delays using the RTT and the UE Tx-Rx time difference (ΔT_{UE}) measurements made as close as possible in time for both cells j, k. It was shown above that both measurements depend on the dispersion factor α(T_{pd,j}). Thus, by solving the ΔT_{UE} and RTT equations, the following is obtained:

(T_{pd,j}+T_{pu,j})=RTTⱼ−ΔT_{UE,j}

(T_{pd,k}+T_{pu,k})=RTTₖ−ΔT_{UE,k}

This provides an evaluation of the total Uu propagation delay and compensates for the delay dispersions α(T_{pd,j}) and α(T_{pd,k}). Using the above formulae, single-sample estimates for the DL propagation delays are obtained as follows (see FIG. 4):

$$\begin{matrix}{\hat{T}}_{pd , j} = \frac{1}{2} ( {RTT}_{j} - Δ {T}_{UE , j} ) \\ {\hat{T}}_{pd , k} = \frac{1}{2} ( {RTT}_{k} - Δ {T}_{UE , k} )\end{matrix}$$

Inter-Cell Time Offset Estimation:

According to the analysis of the “SFNⱼ-SFNₖ observed time difference” measurement discussed above, this measurement has been expressed as follows:

T_{m,k}=θⱼₖ+(T_{pd,j}−T_{pd,k}), 0≦T_{m,k}<t_{f}

OFFₖ=(SFNₖ−SFNⱼ) mod 256, OFFₖ=0, 1, . . . , 255

where θⱼₖ is the true inter cell subframe phase offset.

To approach the estimation problem, define low and high inter-cell time offsets (Y_{jk,L}, Y_{jk,H}) and index offsets (N_{jk,L}, N_{jk,H}) as follows:

Y_{jk,L}=Yⱼₖ mod T_{CFN}=N_{jk,L}*t_{f}+θⱼₖ, where N_{jk,L}=Nⱼₖ mode 256

And, Y_{jk,H}=Yⱼₖ−Y_{jk,L}=N_{jk,H}*t_{f}, where N_{jk,H}=Nⱼₖ−N_{jk,L}

Therefore, the estimation strategy is to compute an estimate Ŷ_{jk,L}=\hat{N}_{jk,L}*t_{f}+\hat{θ}ⱼₖ of the low order inter-cell time offset Y_{jk,L}=N_{jk,L}*t_{f}+θⱼₖ for which the subframe phase offset is not altered by the mod-T_{CFN} operation.

To proceed with computation of the estimates, a “compensated inter-cell phase” \hat{γ}ⱼₖ is defined as follows:

$${\hat{γ}}_{jk} = {T}_{m , k} - ( {\hat{T}}_{pd , j} - {\hat{T}}_{pd , k} ) = {T}_{m , k} - \frac{1}{2} [ ( {RTT}_{j} - Δ {T}_{UE , j} ) - ( {RTT}_{k} - Δ {T}_{UE , k} ) ]$$

Since 0≦T_{m,k}≦t_{f}−0.2604 μ sec and it is conjectured that the difference (\hat{T}_{pd,j}-\hat{T}_{pd,k}) will not exceed an order of magnitude within 10-100 μ sec, \hat{γ}ⱼₖ can be located within −t_{f}<\hat{γ}ⱼₖ<2*t_{f}. The final expressions of the inter-cell estimates are given by:

If \hat{γ}ⱼₖ<0 [symbol] \hat{θ}ⱼₖ=t_{f}+\hat{γ}ⱼₖ & \hat{N}_{jk,L}=(OFFₖ−1) mod 256

If \hat{γ}ⱼₖ≧0 \hat{θ}ⱼₖ=\hat{γ}ⱼₖ mod t_{f} & \hat{N}_{jk,L}=(OFFₖ+└\hat{γ}ⱼₖ/t_{f}┘) mod 256

Then, Ŷ_{jk,L}=\hat{N}_{jk,L}*t_{f}+\hat{θ}ⱼₖ

Here the frame difference OFF is used to correct the offset estimation for wraparound that can result from the use of modulo counters as the local timers at the Node Bs.

Thus, a complete evaluation of the inter-cell time offset estimates have been obtained using a single measurement sample. It remains to evaluate the corresponding estimation error which can be obtained as follows:

$$\begin{matrix}{ϵ}_{jk} = {\hat{Y}}_{jk , L} - {Y}_{jk , L} = {\hat{γ}}_{jk , L} - {γ}_{jk , L} = ( {\hat{T}}_{pd , k} - {\hat{T}}_{pd , j} ) - ( {T}_{pd , k} - {T}_{pd , j} ) \\ = \frac{1}{2} [ ( {T}_{pd , j} - {T}_{pu , j} ) - ( {T}_{pd , k} - {T}_{pu , k} ) ] + {ϵ}_{res}\end{matrix}$$

where εᵣₑₛ is a certain rounding error due to the RTT and UE Tx-Rx measurement resolution, which is yet unknown. Differences between DL and UL Uu propagation delays may exist for possibly asymmetric reflections and shadow fading. The variance of this error can be evaluated by adopting a proper PDF model for those delays. Anyway, the accuracy is excellent and the error, without εᵣₑₛ, is indeed within ±3 μ sec with even large coverage ranges.

Inter-Node B Time Offset Estimation:

As was done for inter-cell time offset estimation above, the low and high inter-Node B time offsets (Y_{iq,L}, Y_{iq,H}) and index offsets (N_{iq,L,} N_{iq,H}) are defined as follows:

Y_{iq,L}=Y_{iq} mod T_{CFN}=N_{iq,L}*t_{f}+θ_{iq}, where N_{iq,L}=N_{iq} mode 256

and,

Y_{iq,H}=Y_{iq}−Y_{iq,L}=N_{iq,H}*t_{f}, where N_{iq,H}=N_{iq}−N_{iq,L}

Once the inter-cell time offset estimates for cells j, k are evaluated, the mapping discussed previously will be used to compute the inter-Node B estimates for Nodes Bᵢ, B_{q}. Then, using the mapping of nodes Bᵢ and B_{q} to cells j & k, to compute the inter-cell estimates for all other pairs of cells belonging to Nodes Bᵢ, B_{q} can be obtained. The mapping procedure is performed as follows:

1. Compute the inter-Node B distance estimate,

λ_{iq}=\hat{θ}ⱼₖ−(T_{cell,ij}−T_{cell,qk})

Then the inter-Node B time offset estimates are obtained as:

If λ_{iq}<0 [symbol] \hat{θ}_{iq}=t_{f}+λ_{iq}& \hat{N}_{iq,L}=(\hat{N}_{jk,L}−1) mod 4096

If λiq≧0 [symbol] \hat{θ}_{iq}=λ_{iq} mod t_{f} & \hat{N}_{iq,L}=(\hat{N}_{jk,L}+└λ_{iq}/t_{f}┘) mod 4096

2. Conversely, compute the inter-cell distance estimate,

λⱼₖ=\hat{θ}_{iq}+(T_{cell,ij}−T_{cell,qk})

Then the inter-cell offset estimates for other cells (also denoted j,k) are obtained as:

If λ_{iq}<0 [symbol] \hat{θ}_{iq}=t_{f}+λ_{iq}& \hat{N}_{iq,L}=(\hat{N}_{jk,L}−1) mod 4096

If λiq≧0 [symbol] \hat{θ}_{iq}=λ_{iq} mod t_{f}& \hat{N}_{iq,L}=(\hat{N}_{jk,L}+└λ_{iq}/t_{f}┘) mod 4096

Then,

Ŷ_{jk,L}=\hat{N}_{jk,L}*t_{f}+\hat{θ}ⱼₖ

The estimation error and its variance will be the same for Nodes Bᵢ and B_{q} and for all pairs of cells {j, k} belonging to these two Nodes B's, i.e.,

$$\begin{matrix}{ϵ}_{iq} = {ϵ}_{jk} = \frac{1}{2} [ ( {T}_{pd , j} - {T}_{pu , j} ) - ( {T}_{pd , k} - {T}_{pu , k} ) ] + {ϵ}_{res} \\ and , {σ}_{iq}^{2} = {σ}_{jk}^{2}\end{matrix}$$

Usage of Inter-Cell Phase Offset Estimates by the Recipient UE:

The recipient UE, which already acquired cell j and seeking acquisition of cell k, can then compute (\hat{θ}ⱼₖ mod Tₛₗₒₜ) and use it to start searching for slot synchronization of cell k, which is the first step in radio synchronization. Then it can use \hat{θ}ⱼₖ itself to start searching for frame synchronization of cell k, as appropriate.

Multi-Stratum (Hierarchical) Inter-Node B Synchronization Approaches

Suppose that Node Bᵢ was chosen as a pivot node and then synchronized to two Nodes Bₚ and B_{q} (which are not in direct view), respectively, using two independent sets of standalone physical measurements. Node Bₚ is then considered a 3^{rd} stratum with respect to Node B_{q} (and vice versa), while nodes Bₚ and B_{q} are considered 2^{nd} stratum with respect to Node Bᵢ which was viewed by both of them. Thus the estimate/variance pair

$$\{ {\hat{Y}}_{ip} , {σ}_{ip}^{2} \}$$

between nodes Bᵢ and Bₚ and the estimate/variance pair

$$\{ {\hat{Y}}_{i q} , {σ}_{i q}^{2} \}$$

between nodes Bᵢ and B_{q} have been obtained. These two estimates are called “single-stratum” or direct estimates, and their accuracy is excellent since their estimation errors are very small as mentioned. The estimate Ŷ_{pq} between nodes Bₚ and B_{q} is called a “two-stratum” estimate and is given by:

Ŷ_{pq}=[Ŷ_{iq}−Ŷᵢₚ]mod T_{CFN} [symbol] ε_{pq}=(ε_{iq}−εᵢₚ)

&

$${σ}_{p q}^{2} = {σ}_{i p}^{2} + {σ}_{i q}^{2}$$

Now assume that a fourth Node Bₛ was viewed by Node B_{q} but not by the other Node Bs, hence the new estimate/variance pair

$$\{ {\hat{Y}}_{q s} , {σ}_{q s}^{2} \}$$

needs to be obtained.

Node B, is then considered 2^{nd} stratum to Node B_{q,}3^{rd} stratum to Node Bᵢ and 4^{th} stratum to Node Bₚ. The estimate of Node Bₛ relative Node Bₚ is a “three-stratum” estimate and is given by:

Ŷₚₛ=[Ŷ_{iq}+Ŷᵢₚ]mod T_{CFN} =[(Ŷ_{iq}−Ŷᵢₚ)+Ŷ_{qs}]mod T_{CFN}

Hence,

εₚₛ=(ε_{iq}−εᵢₚ)+ε_{qs} &

$${σ}_{p s}^{2} = {σ}_{i q}^{2} + {σ}_{i p}^{2} + {σ}_{q s}^{2}$$

A single stratum estimate provides excellent accuracy if available, while the estimation variance multiplies for higher-order stratum estimates. The highest allowed estimation stratum can then be determined in order to satisfy a particular accuracy requirement.

The invention being thus described, it will be obvious that the same may be varied in many ways. Such variations are not to be regarded as a departure from the spirit and scope of the invention, and all such modifications are intended to be included within the scope of the following claims.

We claim:

1. A method of estimating a time offset between link points in a communication network operating in frequency division duplex mode, comprising the step of:
estimating a first time offset between first and second link points based on communication measurements made by equipment of an end user communicating with the first and second link points.

2. The method of claim 1, wherein the first and second link points are one of nodes of a network, base stations of a wireless communication network, and coverage areas of a wireless communication network.

3. The method of claim 1, wherein the first and second link points are one of nodes of a network, base stations of a wireless communication network, and base station resources associated with coverage areas of a wireless communication network.

4. The method of claim 1, wherein the measurements made by the user equipment characterize a communication link between the user equipment and the first link point and characterize a communication link between the user equipment and the second link point.

5. The method of claim 4, wherein the estimating step includes estimating a first down link propagation delay from the first link point to the user equipment based on the measurement made by the user equipment, estimating a second downlink propagation delay from the second link point to the user equipment based on the measurements made by the user equipment, and estimating the first time offset between the first and second link points based on the estimated first and second downlink propagation delays.

6. The method of claim 4, wherein the measurements made by the user equipment include a timing phase difference between receipt of a frame from the first link point by the user equipment and receipt of a frame from the second link point by the user equipment.

7. The method of claim 6, wherein
the measurements made by the user equipment include a frame difference between a frame number for a frame received from the first link point by the user equipment and a frame number for a frame received from the second link point by the user equipment.

8. The method of claim 4, wherein the measurements made by the user equipment include a first receive/transmit differential for information received from the first link point and an associated response sent to the first link point, and a second receive/transmit differential for information received from the second link point and an associated response sent to the second link point.

9. The method of claim 4, wherein the estimating step estimates the first time offset between the first and second link points based on measurements made by user equipment communicating with the first and second link points and measurements made by the first and second link points.

10. The method of claim 9, wherein the measurements made by the first and second link points include a first round trip transmit/receive differential for information transmitted by the first link point to the user equipment and an associated response received from the user equipment and a second round trip transmit/receive differential for information transmitted by the second link point to the user equipment and an associated response received from the user equipment.

11. The method of claim 1, wherein the estimating step includes estimating an initial time offset between the first and second link points based on the measurements made by the user equipment, and correcting the initial time offset estimate for wrap around based on the measurements made by the user equipment.

12. The method of claim 11, wherein the measurements made by the user equipment include a frame difference between a frame number for a frame received from the first link point by the user equipment and a frame number for a frame received from the second link point by the user equipment, and the correcting step corrects the offset estimate using the frame difference.

13. The method of claim 1, wherein
the measurements made by the user equipment include a timing phase difference between receipt of a frame from the first link point by the user equipment and receipt of a frame from the second link point by the user equipment, a first receive/transmit differential for information received from the first link point and an associated response sent to the first link point, a second receive/transmit differential for information received from the second link point and an associated response sent to the second link point; and
the estimating step includes estimating a first down link propagation delay from the first link point to the user equipment based on the first receive/transmit differential and a first round trip transmit/receive differential, estimating a second downlink propagation delay from the second link point to the user equipment based on the second receive/transmit differential and a second round trip transmit/receive differential, and estimating an initial time offset between the first and second link points based on the first and second estimated downlink propagation delays and the timing phase difference; the first round trip transmit/receive differential being a time differential for information transmitted by the first link point to the user equipment and an associated response received from the user equipment and the second round trip transmit/receive differential being a time differential for information transmitted by the second link point to the user equipment and an associated response received from the user equipment.

14. The method of claim 13, wherein the measurements made by the user equipment include a frame difference between a frame number for a frame received from the first link point by the user equipment and a frame number for a frame received from the second link point by the user equipment, and correcting the initial time offset estimate for wrap around based on the frame difference.

15. The method of claim 1, wherein the estimating step includes estimating a second time offset between first and third link points based on measurements made by a first user equipment in communication with the first and third link points, estimating a third time offset between second and third link points based on measurements made by a second user equipment, and estimating the first time offset based on the second and third estimated time offsets.

16. The method of claim 1, wherein
the first and second link points are cells; and further including the step of,
estimating a second time offset between a first node including the first cell and a second node including the second cell based on the first estimated time offset.

17. The method of claim 1, wherein
the first and second link points are nodes; and further including the step of,
estimating a second time offset between a first cell in the first node and a second cell in the second node based on the first estimated time offset.

18. The method of claim 1, wherein a time offset comprises an integer frame offset in units of information frames and a timing phase offset which is a fraction of an information frame period.

19. A central node for estimating a time offset between link points in a communication network operating in frequency division duplex mode, the central node being adapted to instruct equipment of an end user communicating with first and second link points to make communication measurements, receive the measurements from the user equipment and estimate a first time offset between the first and second link points based on the measurements made by the user equipment.

20. The central node of claim 19, wherein the first and second link points are one of base stations of a wireless communication network and coverage areas of a wireless communication network.

21. The central node of claim 19, wherein the measurements made by the user equipment characterize a communication link between the user equipment and the first link point and Characterize a communication link between the user equipment and the second link point.

22. The central node of claim 21, wherein the central node estimates a first down link propagation delay from the first link point to the user equipment based on the measurements made by the user equipment, estimating a second downlink propagation delay from the second link point to the user equipment based on the measurements made by the user equipment, and estimating the first time offset between the first and second link points based on the estimated first and second downlink propagation delays.

23. The central node of claim 19, wherein
the central node instructs the user equipment to make (a) a timing phase difference measurement, which is the timing phase difference between receipt of a frame from the first link point by the user equipment and receipt of a frame from the second link point by the user equipment, (b) a first receive/transmit differential measurement, which is the time difference between when information is received from the first link point and an associated response is sent to the first link point, (c) a second receive/transmit differential measurement, which is a time difference between when information is received from the second link point and an associated response is sent to the second link point;
the central node instructs the first link point to make a first round trip transmit/receive differential measurement, which is a time difference between when information is transmitted by the first link point to the user equipment and an associated response is received from the user equipment;
the central node instructs the second link point to make a second round trip transmit/receive differential, which is a time difference between when information is transmitted by the second link point to the user equipment and an associated response is received from the user equipment; and
the central node estimates a first down link propagation delay from the first link point to the user equipment based on the first receive/transmit differential and the first round trip transmit/receive differential, estimates a second downlink propagation delay from the second link point to the user equipment based on the second receive/transmit differential and the second round trip transmit/receive differential, and estimates an initial time offset between the first and second link points based on the first and second estimated downlink propagation delays and the timing phase difference.

24. The central node of claim 23, wherein
the central node instructs the user equipment to make a frame difference measurement, the frame difference measurement is a difference between a frame number for a frame received from the first link point by the user equipment and a frame number for a frame received from the second link point by the user equipment; and
the central node corrects the initial time offset estimate for wrap around based on the frame difference.

25. Apparatus for estimating a time offset between link points in a communication network operating in frequency division duplex mode, the apparatus comprising:
means for instructing equipment of an end user communicating with first and second link points to make communication measurements;
means for receiving the measurements from the user equipment; and
means for estimating a first time offset between the first and second link points based on the measurements made by the user equipment.

26. The apparatus of claim 25, wherein the first and second link points are one of base stations of a wireless communication network and coverage areas of a wireless communication network.

27. The apparatus of claim 25, wherein the measurements made by the user equipment characterize a communication link between the user equipment and the first link point and characterize a communication link between the user equipment and the second link point.

28. The apparatus of claim 27, wherein the means for estimating estimates a first down link propagation delay from the first link point to the user equipment based on the measurements made by the user equipment, estimates a second downlink propagation delay from the second link point to the user equipment based on the measurements made by the user equipment, and estimates the first time offset between the first and second link points based on the estimated first and second downlink propagation delays.

29. The apparatus of claim 25, wherein
the instructing means instructs the user equipment to make (a) a timing phase difference measurement, which is the timing phase difference between receipt of a frame from the first link point by the user equipment and receipt of a frame from the second link point by the user equipment, (b) a first receive/transmit differential measurement, which is the time difference between when information is received from the first link point and an associated response is sent to the first link point, (c) a second receive/transmit differential measurement, which is a time difference between when information is received from the second link point and an associated response is sent to the second link point;
the instructing means instructs the first link point to make a first round trip transmit/receive differential measurement, which is a time difference between when information is transmitted by the first link point to the user equipment and an associated response is received from the user equipment;
the instructing means instructs the second link point to make a second round trip transmit/receive differential, which is a time difference between when information is transmitted by the second link point to the user equipment and an associated response is received from the user equipment; and
the estimating means estimates a first down link propagation delay from the first link point to the user equipment based on the first receive/transmit differential and the first round trip transmit/receive differential, estimates a second downlink propagation delay from the second link point to the user equipment based on the second receive/transmit differential and the second round trip transmit/receive differential, and estimates an initial time offset between the first and second link points based on the first and second estimated downlink propagation delays and the timing phase difference.

30. The apparatus of claim 29, wherein
the instructing means instructs the user equipment to make a frame difference measurement, the frame difference measurement is a difference between a frame number for a frame received from the first link point by the user equipment and a frame number for a frame received from the second link point by the user equipment; and
the estimating means corrects the initial time offset estimate for wrap around based on the frame difference.

31. Communication equipment, comprising:
receiving means receiving instructions to make (a) a timing phase difference measurement, which is the timing phase difference between receipt of a frame from a first link point by the communication equipment and receipt of a frame from a second link point by the user equipment, (b) a first receive/transmit differential measurement, which is the time difference between when information is received from the first link point and an associated response is sent to the first link point, (c) a second receive/transmit differential measurement, which is a time difference between when information is received from the second link point and an associated response is sent to the second link point; and
measurement means measuring the timing phase difference, the first receive/transmit differential and the second receive/transmit differential; and
transmitting means transmitting the output of the measurement means.
